(19) United States
(12) Patent Application Publication
(10) Pub. No.: US 2004/0155104 A1
(43) Pub. Date: Aug. 12, 2004

(54) Transaction card with indexed thermal printing for gaming systems

(75) Inventor: Chauncey T. Mitchell JR., Lakeland, TN (US)

Correspondence Address: Stephen B. Salai, Esq., Harter, Secrest & Emery LLP, 1600 Bausch & Lomb Place, Rochester, NY, 14604-2711, US

(73) Assignee: Translucent Technologies, LLC, Algoma, WI

(21) Appl. No.: 10/771,216

(22) Filed: Feb. 3, 2004

Related U.S. Application Data
(60) Provisional application No. 60/444,515, filed on Feb. 3, 2003.

(51) Int. Cl. G06K 5/00

(52) U.S. Cl. 235/380

(57) ABSTRACT

A multi-use transaction card, which is particularly useful for holding and transferring value between gaming machines, includes both a machine-readable area and a thermally printable area. The machine readable area links the card to account information in a host processor. The thermally printable area provides a visible indication of the status of the account. The account balance of the card can be updated with use, and the thermally printable area can be reprinted with updated information. A succession of updated entries can be thermally printed on the cards. All but the most recent entry are overprinted with a cross-out or other pattern as an indication that the prior entries are no longer current.

### CROSS-REFERENCE TO RELATED APPLICATIONS

This application claims priority to U.S. Provisional Application No. 60/444,515, which application is hereby incorporated by reference.

### BACKGROUND OF THE INVENTION

1. Field of the Invention

Magnetic striped cards, “smart cards”, and other encoded instruments contain account or other control information that can be accessed in connection with their use. The invention envisions applying a thermally printable layer to the instruments as a visible medium for recording a sequence of transaction results. A processing system for the instruments, which is particularly applicable to gaming systems, relates the control information to the transactions and prints updated results on the thermally printable layer.

2. Description of Related Art

The gaming industry is generally moving toward cashless systems to simplify the maintenance, security, and operation of their machines. While most gaming machines still accept cash including various forms of coins and currency, the preferred payout is now in the form of scrip or other redeemable instruments. The scrip is printed by the gaming machines with a code (e.g., barcode) containing a control number that is associated by a host computer with a redeemable value. In addition, the scrip is printed on its face with the redeemable value referenced by the control number.

The scrip, which is payable to its bearer, can be used just once to redeem into cash or to transfer its value as a gaming machine credit (i.e., positive balance in a temporary account) for further play. New scrip is printed by the gaming machines each time a player cashes out with a new control number and a new value.

Multiple use media is expected to simplify credit exchanges with gaming machines and to reduce both maintenance and media costs. For example, electronically encoded cards, such as “smart cards” and magnetically striped cards have been proposed for replacing other forms of gaming machine payouts. The electronically encoded cards can include electronically encoded account numbers or other reference data that can be associated with a sequence of transactions. For example, the account numbers can reference an updateable account in the host computer. A positive balance on account can be updated each time a player cashes out.

The electronically encoded cards can be inserted into gaming machines for transferring credit similar to the scrip. However, when the player cashes out, the same card that was originally inserted into the gaming machine can be returned to the player to transfer the credit to the same or a different gaming machine or to redeem the credit for cash. The electronically encoded cards, which are payable to their bearers like scrip, can be reused by referencing different values each time they are returned to the player.

While the electronic account transactions with the host computer can enhance security, the lack of a visible record of the current account balance on the cards can be a source of confusion or controversy to their users. Once disjoined from a gaming machine or other connection to the host computer, the redeemable account balance carried by the cards is inaccessible. The account balance associated with each card can change many times, and the time between transactions can vary widely. With reliance solely on player (user) memory to corroborate the transfers, misunderstandings can be expected to result. Some players may be reluctant to accept payouts in the form of electronically encoded cards having no visible value or other confirmation that the cards are even electronically readable.

### BRIEF SUMMARY OF THE INVENTION

My invention, which is particularly applicable to gaming machine transactions, includes a new transaction card processing system and a new transaction card made from a reusable media that can be encoded with account numbers or other reference data and can also be printed in a permanent form to provide visible records of account balances or other information. For example, the encoded account numbers can be read by a gaming machine and associated in a host computer with a positive balance. Upon cash out, a new positive balance can be associated with the account number in the host computer and can be visibly printed on the reusable media. The printing is preferably permanent, and each new balance is preferably printed in a succession of available spaces on the reusable media. Players are expected to more readily accept the new transaction cards as the equivalent of cash payouts, because the cash equivalent is visibly printed on the cards.

A reusable medium in accordance with my invention can be encoded with account information that is machine-readable for associating a succession of positive account balances with the reusable medium. A printable space on a surface of the reusable medium provides for recording the succession of account balances or similar entries in a visible form. The individual account balances are preferably printed in a permanent form that can be subsequently crossed out or entirely blocked out but cannot be erased. Each new account balance occupies a different portion of the printable space on the surface of the reusable medium.

The reusable medium can be made from a variety of materials including plastic, film, and card stocks in single-ply or multiple-ply forms. The account information can be encoded electronically, such as on a magnetic stripe or in a non-volatile memory, or can be encoded in other machine accessible ways. Optical encoding, for example, can be used to record information in symbol formats that can be detected by optical readers or scanners. The printable space on the surface of the reusable medium is preferably formed by a thermosensitive-imaging layer that can be imaged by direct thermal printers. Heat patterns produced by the thermal printers cause localized areas of the thermosensitive-imaging layer to undergo permanent color change for producing correspondingly patterned images.

The capabilities of the reusable media for encoding account reference information and for printing account balances or similar entries can be adapted for use as transaction cards conveying positive balances to and from gaming machines. The transaction cards can be inserted into gaming machines that are modified to read the encoded account information and to write individual balances in the printable space on the cards. For example, a reader, such as a magnetic reading head, a “smart-card” receiver, or an optical scanner, can access the encoded account reference information. An account balance can be associated with the account reference information by the gaming machine or by a host computer in communication with the gaming machine. As a part of a cash out sequence from the gaming machine, the account balance can be updated with the host computer and printed on the surface of the transaction card in a next available space.

Physical reference information can be extracted from the transaction card for locating the next available space for printing. For example, a sensor can be adapted for detecting occupied print spaces and for indexing the transaction card to the next available space for printing a new account balance. Alternatively, the number of balances already printed on the transaction card can be stored in the host computer or on the transaction card, and this information, in conjunction with information referencing the relative location of the transaction card in the printer, can be used to position the transaction card for printing in the next available space.

Along with the printing of new account balances, the immediately preceding account balances can be struck through or otherwise overprinted to avoid confusion with the new account balances. The overprinted account balances can remain visible to reveal an account history or can be completely blocked out to conceal the account history. When all of the available print spaces have been filled; the gaming machine can dispense a replacement transaction card printed with the new balance.

Preferably, the filled transaction cards are retained within the gaming machines, and replacement cards are dispensed from the gaming machines with the same or a new account number. Each replacement transaction card can be pre-encoded with a unique account number, or the gaming machine can be further modified to encode account numbers on the transaction cards. For security purposes, the replacement cards are preferably encoded with new account numbers so that no two cards contain the same account number. However, the old account numbers from the filled cards can be linked with the new account numbers of the replacement transaction cards to record continuous strings of transactions by individual players.

In addition to gaming machines, the transaction cards can be dispensed from kiosks or customer service centers. The kiosks and customer service centers can also be arranged to redeem the transaction cards into cash or cash equivalents. The transaction cards can be stored within machines as individual cards in stacks or as a continuous sequence of interconnected cards, such as a fan-folded stack or wound bandoleer.

An exemplary method for cashing out gaming machines includes reporting a gaming machine credit as an account balance to a host computer. The account balance is associated with an account reference number in the host computer. The account reference number, which can be composed of a full range of alphanumeric characters or other interpretable symbols, is encoded on a transaction card. In addition, the account balance is printed on the transaction card in one of a plurality of spaces intended for printing a series of account balances. The encoded and printed transaction card is dispensed from the gaming machine.

The same transaction card can be used to transfer a cash equivalent to the same or a different gaming machine. As a part of an exemplary startup sequence, the transaction card is inserted into the gaming machine, and the encoded account reference number is read by the gaming machine and shared with the host computer. The account balance associated with the account reference number is communicated by the host computer to the gaming machine and is made available for play as a game credit. The available credit is updated in the gaming machine as the result of each play but is preferably communicated to the host computer when the player has elected to cash out.

The same transaction card can also be used multiple times to withdraw cash equivalents from the same or a different gaming machine. As a part of an exemplary cash out sequence, the transaction card is fed into a printer that senses or otherwise determines a next available space for printing on the transaction card and prints the new account balance on the transaction card. The prior printed account balance can be struck through or otherwise overprinted as desired. The transaction card can retain the same account reference number, or a new reference number can be assigned to the card by the host computer and can be encoded into the transaction card by the gaming machine. The transaction card is preferably dispensed through the same slot that it was earlier inserted into the gaming machine.

In addition to writing current account balances on the transaction cards, printers within the gaming machines or other machines that dispense the transaction cards can print other information. For example, the current account balances can be printed along with the time or date and type of transaction such as deposit, update, or transfer. Timely promotional information can be printed on the transaction cards to reward patrons or to advertise other games or activities. A duplicate or cross-referenced account reference number can also be printed on the transaction cards as a failsafe measure in the event that the encoded account reference number becomes unreadable.

The new printable transaction cards can also contain expanded or additional mediums including memory for recording additional information related to the transactions. For example, the transaction cards can record or provide reference to information for customer loyalty programs independently of the changes in account balance. Independent control codes can be associated with the different types of transactions to preserve the anonymity of players in connection with any financial accounting of their gaming activities. Thus, the transaction cards can provide the anonymity of cash transactions while still allowing the bearers to link their identity with other aspects of their play.

### BRIEF DESCRIPTION OF THE SEVERAL VIEWS OF THE DRAWING(S)

FIG. 1 is, a front view of an exemplary transaction card in the form of a magnetic stripe card having a prescribed area for indexed thermal printing.

FIG. 2 is a back view of the exemplary transaction card of FIG. 1 having a magnetic stripe and a barcode for encoding account reference numbers.

FIG. 3 is a front view of an alternative exemplary transaction card in the form of a “smart card” having a prescribed area oriented along a length of the card for indexed thermal printing.

FIG. 4 is a front view of an alternative exemplary transaction card in the form of an optically encoded card having a prescribed area oriented along a length of the card for indexed thermal printing.

FIG. 5 is a schematic view of a transaction card processing system within a gaming machine.

### DETAILED DESCRIPTION OF THE INVENTION

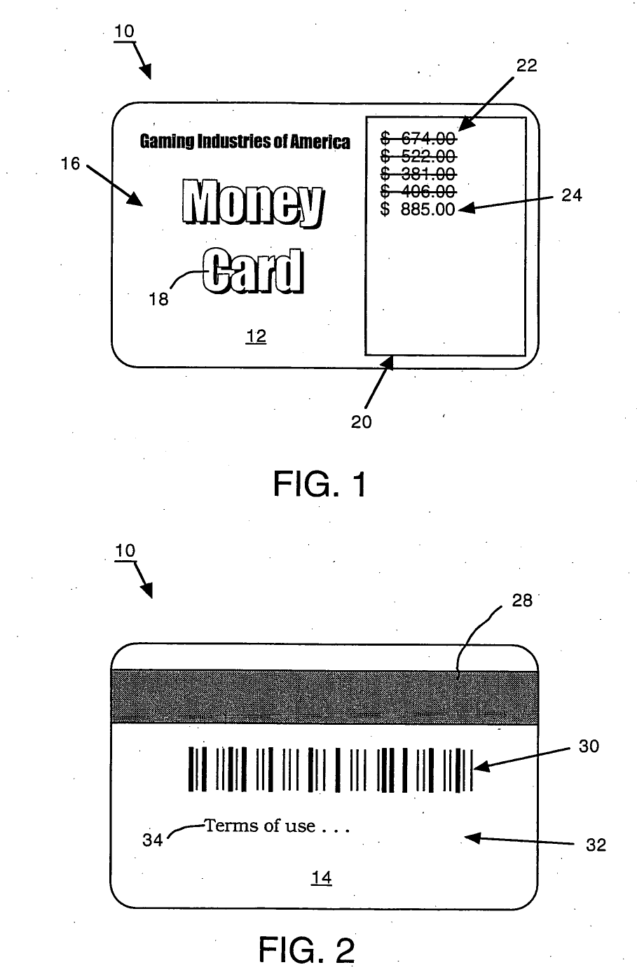

An electronically encodeable transaction card 10 is depicted in FIGS. 1 and 2. On a front surface 12 of the transaction card 10 shown in FIG. 1, a graphics area 16 is printed with a logo, graphics, or other information 18 for such purposes as identifying the issuer of the transaction card 10 or its intended venue for use. A thermally printable area 20 also appears on the face 12 of the transaction card 10 for recording a succession of balances 22. All but the most recent balance 24 have been struck through but are still readable.

On a back surface 14 of the transaction card 10 shown in FIG. 2, a magnetic stripe 28 extends across a length of the transaction card 10 for encoding an account reference number or other reference data in a machine readable form. Although referred to as an “account reference number”, a full range of alphanumeric characters and other symbols can be used in addition to or as a substitute for numbers to reference the account. A barcode 30 appearing on the back face 14 provides duplicate, supplemental, or independent reference information, also in a machine-readable form. A graphics area 32 on the remainder of the card 10 is printed with other visible information 34, such as instructions, promotions, or terms of use.

The graphic areas 16 and 32 appearing on the front and back surfaces 12 and 14 are preferably preprinted in a batch process, such as in-line printing. The barcode 30 can also be preprinted for such purposes as identifying the transaction cards independently of the reference data subsequently encoded in the magnetic stripe 28. A linkage between the information encoded magnetically by the magnetic stripe 28 and the information encoded optically by the barcode 30 can be established preceding or during use for purposes of security, auditing, or backing up the reference data on the card. For example, the magnetic stripe 28 could be initially encoded to match the information encoded by the barcode 30, so that when the magnetic stripe 28 is first read, the reference information encoded in the barcode 30 is linked to subsequent transactions of the card 10. If the magnetic stripe 28 were later rendered unreadable, balance information could still be traced through the barcode 30.

The transaction card 10 is preferably constructed from a reusable medium such as plastic, film, or card stock in a single-ply or multiple-ply form. Coatings can be applied to the front and back surfaces 12 and 14 for such purposes as enhancing printing, appearance, and durability.

The thermally printable area 20 on the front surface 12 of the transaction card 10 is preferably formed by a coating of a thermosensitive imaging material that can be imaged by the controlled application of heat. Conventional thermosensitive coatings are based on leuco dyes containing a color former, a developer, and a sensitizer. Under heat applied by a thermal printer, the color former reacts with the color developer to form the final image. Typical thermal printers have heat-generating print heads containing linear arrays of tiny resistive heating elements that are arranged perpendicular to a feed direction through the printer. Each thermal print head element locally heats an area of the thermosensitive coating directly under the print element for changing the color of the locally heated area. Such direct thermal printing is reliable, inexpensive, and virtually maintenance free because the printer is not required to administer ink.

The thermosensitive imaging material of the thermally printable area 20 can be imaged in a single color or in multiple colors, which are generally developed by the application of different amounts of heat. For example, the balances 22 and 24 can be thermally printed in a first color (e.g., black) and struck through in a second color (e.g., red). Coatings can be applied over or under the coating of thermosensitive imaging material for such purposes as resting UV light exposure, chemicals, and abrasion.

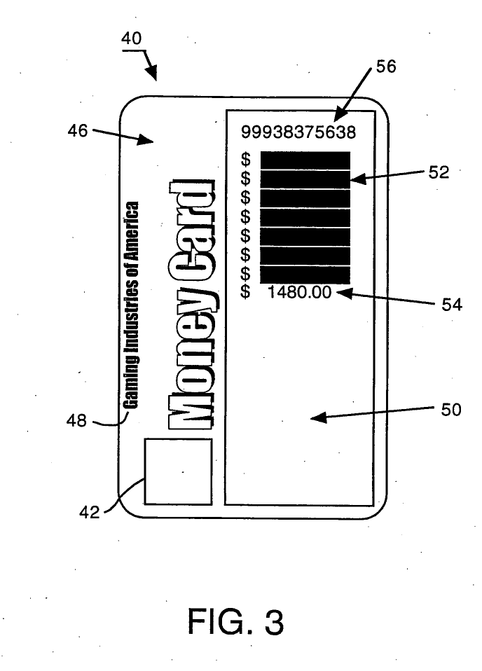

An alternative electronically encoded transaction card 40 shown in FIG. 3 is built upon a “smart card” having an embedded memory chip 42 for electronically encoding an account reference number or other reference data in a machine readable form. Additional “smart card” capabilities including storing value, securing access, and managing loyalty programs can be used for enhancing gaming transactions. These and other capabilities can also be used for different purposes, such as conducting e-commerce and managing personal finances, which can be integrated with or maintained separately from the gaming transactions. For example, current account balances can be securely stored within the memory chip 42 for duplicating or even replacing functions of a host computer.

Similar to the transaction card 10 of FIGS. 1 and 2, the transaction card 40 of FIG. 3 includes a graphics area 46 printed with a logo, graphics, or other information 48 and a thermally printable area 50 for recording a succession of balances 52. All but the most recent balance 54 has been blocked out entirely from view. In contrast to the transaction card 10, the thermally printable area 50 is oriented along a 12 length of the transaction card 40 to provide room for more balance entries 52. The lengthwise orientation of the thermally printable area 50 is not specific to “smart cards” and could be equally well applied to the magnetically striped transaction card 10 or other forms of transaction cards providing alternative means for encoding account reference information.

A control code 56 is also printed within the thermally printable area 50. The control code 56, which is shown as being drawn from a numerical character set, could also be encoded in other optically readable forms, such as a single- or multi-dimensional barcode. The control code 56 provides an alternative means for accessing balance information stored elsewhere. Although a single control code 56 is depicted, a different control code could be printed with each new balance. Such additional control codes would preferably be encoded in a more compact form.

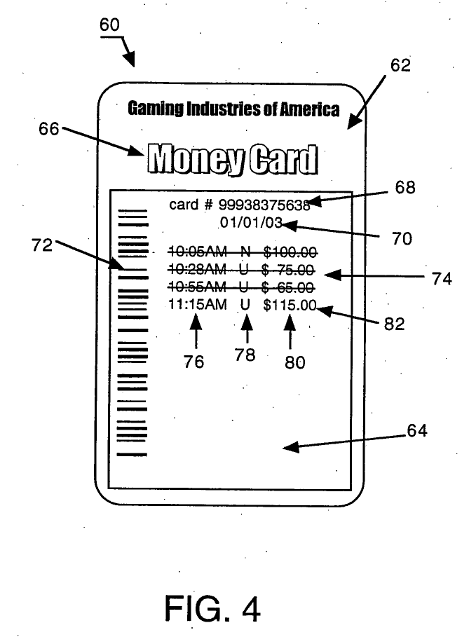

Another layout for a transaction card is shown in FIG. 4. A transaction card 60 has a preprinted graphics area 62 and a thermally printable area 64. The preprinted graphics area 62 contains a logo 66 and other information. The thermally printable area 64 is printed with a card number 68, the print date 70, a barcode control code 72 along with a succession of balance entries 74. Each of the balance entries 74 includes a time stamp 76, a transaction type code 78 (e.g., new, transfer, deposit, update), and a dollar balance 80. All but the last balance 82 is struck through.

The card number 68 and the control code 72 provide optically encoded reference information for identifying the transaction card 60 and for associating the transaction card 60 with an account that holds a current balance. The reference information provided by the card number 68 and the control code 72 can duplicate each other or be unique. Preferably, one or both of the card number 68 and the barcode control code 72 are assigned by a host computer and are thermally printed when the transaction card 60 is first issued. However, each of the balance entries 74 could also be associated with a unique reference code. Both the card number 68 and the control code 72 can be optically encoded in different ways that are machine readable, such as multidimensional optical codes. A magnetic stripe, a memory chip, or other encoding means could be used in addition to or as an alternative to the card number 68 and the control code 72 for referencing the same account.

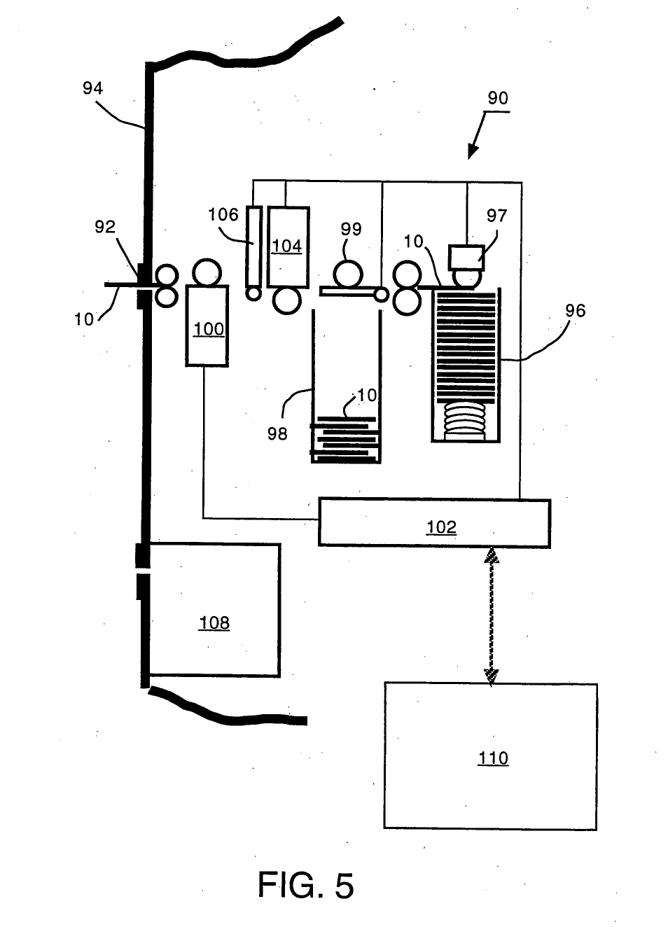

A transaction card processing system 90 is depicted in FIG. 5 mounted behind a slotted opening 92 in a gaming machine 94. The system is specially adapted for processing the transaction cards 10 of FIGS. 1 and 2. A supply of new transaction cards 10 is stored in a magazine 96, which is automated by a drive apparatus 97 for dispensing the cards 10 on demand. Previously issued transaction cards 10 can be inserted into the processing system 90 through the slotted opening 92. Expended transaction cards 10 (i.e., cards whose previous balances 22 have entirely overwritten the allocated space of the thermally printable area 20 or whose current balance is zero) are reclaimed and securely stored in a bin 98. A route deflector 99 is depicted for directing the spent cards 10 into the bin 98.

A magnetic stripe reader/writer 100 provides for reading and writing encoded information on the magnetic stripes 28. The reader/writer 100 communicates through a processing interface 102 with a host processor 110 for exchanging information concerning the magnetically encoded contents of the magnetic stripes 28.

A direct thermal printer 104 together with a position sensor 106 provides for writing the new balances 24 on the cards 10 and for striking out or otherwise overwriting the prior balances 22 that were earlier thermally printed on the cards 10. The position sensor 106 detects the position of the cards 10 approaching the thermal printer 104 for registering the thermally printable area 20 with respect to the printer 104. The position sensor 106 can also be arranged to be optically sensitive to reference marks (e.g., dollar signs) previously printed on the cards to locate the most recent balance 24 and the next available space for printing. The printer 104 also communicates with the processing interface 102 to acquire instructions for overprinting the most recent balance 24 and for printing a new current balance.

The processing interface 102 integrates the transaction card processing system 90 into the electronic systems of the gaming machine 94, including a cash acceptor 108, and as well as into the host computer 110, which provides central processing capabilities for a plurality of gaming machines 94. The host computer 110 preferably provides for storing and exchanging account information associated with the transaction cards 10 in connection with both the entrance and exit of the transaction cards 10 from the gaming machine 94. The dispensing of new cards 10 from the magazine 96 and the reclaiming of spent cards 10 into the bin 98 also preferably produce information exchanges with the host computer 110.

The cash acceptor 108 can be of a type that accepts various forms of cash or cash equivalents including currency, coins, or debit account transfers. Information concerning the deposit of cash in the cash acceptor can be stored in the gaming machine 94 to update a local credit balance in the machine 94 or can be shared with the host computer 110 to update an account associated with a particular transaction card 10. Once established in connection with a transaction card 10, the balance of the account can be affected by deposits of cash, the results of play, or a complete or partial redemption of cash held by the transaction card 10.

The transaction card processing system 90 is specifically arranged for processing the magnetically striped transaction cards of FIGS. 1 and 2. However, the processing system 90 can be readily modified in accordance with the invention to accommodate other types of transaction cards, such as the “smart card” transaction card 40 of FIG. 3 and the optically encoded transaction card 60 of FIG. 4. For example, the magnetic stripe reader/writer 100 could be replaced by comparable mechanisms for reading or writing in other mediums including such mechanisms that communicate through electrical, optical, or radio interfaces. At a minimum, the comparable mechanisms preferably perform a reading function for acquiring account information from the transaction cards.

Additional reading or writing devices can be used for related purposes, such as reading the barcode 30 as a further verification of or as a backup to the primary encoded account reference. A verification device could also be used to read the printed balance, compare the printed balance to the electronically stored balance, and initiate a reprint or other error routine if the balances do not match.

A similar processing system could be mounted in a kiosk or customer service center to dispense or redeem the transaction cards 10. For redemption purposes, the transaction card processing system 90 can be linked to a cash surrender device that returns cash or a cash equivalent (e.g., debit account transfer) to the bearer in return for a partial or complete withdrawal from the account balance of the transaction card 10. In the case of a partial withdrawal, the remaining balance can be printed on the transaction card 10 and returned to the bearer, but the transaction card 10 is preferably not returned if the withdrawal is complete.

According to the invention, gaming machine play can be initiated by depositing cash or a cash equivalent into the cash acceptor 108 of the gaming machine 94 or by inserting a previously issued transaction card 10 into the transaction card processing system 90. If cash is deposited, the transaction card processing system 90 issues a new transaction card 10 at cash out. The new transaction card 10 is dispensed through the slot 92 to the player as a cash equivalent of the current credit amount cashed out by the player.

The new transaction card 10 can be initiated to its bearer value in a variety of ways. We prefer that the cash-out amount, together with an indicator of the gaming machine 94 and any prior account reference number, be communicated to the host computer 110. An account reference number, which can be changed for each transaction of the transaction card 10, is preferably assigned by the host computer 110 and communicated to the processing interface 92 of the transaction card processing system 90. The host computer 110 preferably stores the current account reference number and balance.

The drive apparatus 97 draws a new transaction card 10 from the magazine 96 and advances the card in sequence through the thermal printer 104 and the magnetic stripe reader/writer 100 (in either order) before dispensing the new transaction card through the slot 92. The thermal printer 104, together with its position sensor 106, locates a first space within the thermally printable area 20 and prints the current balance 24. The magnetic stripe reader/writer 100 encodes the account reference number on the magnetic stripe 28. Additional information can be written by both the thermal printer 104 and the magnetic stripe reader/writer 100. For example, the thermal printer 104 could print the account reference number in conventional alphanumeric characters or in an encoded form (e.g., a multidimensional barcode). The magnetic stripe reader/writer 100 could also encode the current balance or other associated information such as the machine that issued or last dispensed the transaction card 10.

Once dispensed, the transaction card 10 can be reused in other gaming machines 94 or redeemed at a kiosk or customer service center. When the transaction card 10 is reinserted into the same or a new gaming machine 94, the magnetic stripe reader/writer 100 reads the encoded account reference number on the card 10, and the processing interface 102 accesses the host computer 110 to associate the account reference number with a current balance. Additional information could also be accessed from the transaction card 10, such as relating to its origins or prior use, which could also be stored in the host computer 110 to verify the transaction card's authenticity.

The account balance referenced by the transaction card 10 is made available for gaming machine play. At cash out, a sequence is initiated that communicates the current balance and any desired related information to the host computer 110 to replace the current balance under the same or a newly assigned account reference number. The new account reference number or any desired related information can be re-encoded into the magnetic stripe 28 or the transaction card 10 can be advanced directly to the thermal printer 104.

A sequence of operations associated with the thermal printer 104 provides for locating the last entered balance and the next available space for printing within the thermally printable area 20. Various locating routines can be used for this purpose. For example, reference marks can be printed along with the account balances in predetermined locations whose presence or absence indicates the availability of a printable space. The reference marks can be checked in sequence to determine the last entry and counted to determine if the transaction card is full. Information concerning the number of previous entries could also be encoded into the magnetic stripe 28 or stored in another accessible form (e.g., a memory chip) on the transaction card 10. Once the relative position of the transaction card 10 is determined, the last entry and next available space could be reference by calibrated motions of the printer feed mechanism.

While printing the new account balance 24, the previous account balance is struck through or otherwise overwritten. An example of a strike through is shown in FIG. 1; an example of a complete block out is shown in FIG. 3. The printing of new account balances and the overwriting of previously printed balances can be carried out in the same or different color inks. Temperature variations in the thermal printer can be used to release different colors in a multicolor thermosensitive coating.

If the transaction card 10 is full (i.e., the available thermally printable space 20 is exhausted), the route deflector 99 preferably directs the spent transaction card 10 into the bin 98, and a new transaction card is issued and returned to the player. The route deflector 99 could also deflect a used transaction card 10 into the bin 98 in the event that the player elects to cash out with a zero balance. Transaction cards 10 printed with positive balances are returned to the players through the slot 92 for additional play or redemption.

Similar procedures can be carried out with other types transaction cards, including the transaction cards 40 and 60, distinguished mainly by alternative ways of encoding account reference information. For example, the transaction card processing system 90 could be arranged to similarly process the transaction card 40 by replacing the magnetic stripe reader/writer 100 with a “smart card” reader/writer. The transaction card 60 could be similarly processed by replacing the magnetic stripe reader/writer 100 with an optical scanner and relying on the thermal printer 104 to provide corresponding writing capabilities.

Expanded interactions between the transaction cards 10, 40, or 60, the gaming machine 94, and the host computer 110 are possible for accomplishing other functions such as the administration of customer loyalty programs or other promotions, the accumulation of marketing information, or the enhancement of security. For example, in addition to storing the current account reference number and balance in the host computer 110, a prior sequence of related transactions involving the same or a replacement transaction card 10 could also be stored in the host computer 110. Such archival information could be accessed by customer choice to assign loyalty awards or by administrative choice to monitor for fraud or marketing purposes. Similar information could also be stored in and accessed from “smart card” transaction cards 40.

Our preferred transaction cards 10, 40, and 60 to the extent that they are used as a substitute for cash, are payable to their bearer without requirement for further identification. Electronically accumulated information concerning the actual transactions of the card is preferably not linked to the bearer's identity unless the bearer so chooses. Processing, such as the accumulation of customer loyalty credit, can be accumulated in parallel and associated with a bearer's identity without establishing any link to the transactions themselves.

1. A transaction card processing system comprising:
a transaction card having a machine-readable area for encoding an account reference and a thermally printable area for printing a succession of account status items;
a reader that accesses the account reference encoded in the machine-readable area of the transaction card;
a processor that links the accessed account reference with a current account status item;
a status item locator sensor that distinguishes between a first space within the thermally printable area that is printed with a prior status item and a second space within the thermally printable area that is not printed with a prior status item; and
a direct thermal printer that overprints the prior status item in the first space with a null pattern and that prints a new status item in the second space within the thermally printable area.

2. The system of claim 1 in which the direct thermal printer prints a cross-out pattern over the prior status item as an indication that the prior status item is no longer current.

3. The system of claim 2 in which the cross-out pattern partially but not completely obscures the prior status item.

4. The system of claim 2 in which the cross-out pattern completely obscures the prior status item.

5. The system of claim 1 further comprising a router for moving the transaction card past the reader, the status item locator sensor, and the direct thermal printer, and in which the status item locator sensor provides for detecting that the thermally printable area is full of prior status items and the router provides for transporting the transaction card to a storage bin to prevent further use of the transaction card.

6. The system of claim 5 in which the router also provides for drawing a new transaction card from a magazine and moving the transaction card past both the reader for linking an account reference and the direct thermal printer for thermally printing a new status item in the thermally printable area.

7. The system of claim 1 in which the processor includes a processing interface for integrating the transaction card processing system with electronic systems of a gaming machine including a cash acceptor and a host computer.

8. The system of claim 7 further comprising data storage for storing information concerning the acceptance of cash by the cash acceptor and a local credit balance within the gaming machine, and in which the processing interface accesses the data storage for printing the new status item as a current account balance.

9. The system of claim 1 further comprising a verification device that reads the prior status item and compares the prior status item to information accessed by the processor that links the accessed account reference to the prior status item.

10. A transaction card processing machine comprising:
an opening that receives a transaction card having a thermally printable area for making a succession of thermally printed entries;
a verifier that checks the authenticity of the transaction card;
a position sensor that locates a last of the succession of thermally printed entries and that locates a succeeding space within the printable area for printing a new thermally printed entry;
a thermal printer that overprints the last of the succession of thermally printed entries as an indication that the last entry is no longer current and that prints the new thermally printed entry within the succeeding space.

11. The machine of claim 10 further comprising a supply of transaction cards stored within the machine, a bin for storing spend transaction cards within the machine, and a router for directing spent transaction cards to the bin and for drawing new transaction cards from the supply of transaction cards.

12. The machine of claim 11 further comprising a processing interface that receives information from the position sensor that the thermally printable area is full and that instructs the router to move the full transaction card to the bin and to draw a new transaction card from the supply of transaction cards.

13. The machine of claim 12 in which the router moves the new transaction card past the thermal printer for printing a new thermally printed entry and dispenses the new transaction card through the opening.

14. The machine of claim 10 in which the verifier communicates with a host processor for exchanging information concerning encoded contents of the transaction cards.

15. The machine of claim 13 in which the verifier includes a reader for reading the new thermally printed entry and for comparing the new thermally printed entry with information from the host processor.

16. The machine of claim 10 in which the thermal printer overprints the last of the succession of thermally printed entries with a cross-out pattern as an indication that the last entry is no longer current.

17. The machine of claim 16 in which the thermal printer overprints the last of the succession of thermally printed entries with a cross-out pattern that partially but not completely obscures the last entry.

18. The machine of claim 16 in which the cross-out pattern completely obscures the last entry.

19. The machine of claim 10 in which the thermal printer prints a reference mark together with the new entry for assisting the position sensor in locating the entry in association with a new transaction.

20. A multi-use transaction card comprising:
a substrate;
a machine-readable area encoding information identifying the transaction card;
a printable area printed with a succession of entries;
the printable area containing at least one prior printed entry and a new printed entry; and
the at least one prior printed entry being overprinted with a cross-out pattern as an indication that the prior printed entry is no longer current.

21. The card of claim 20 in which the cross-out pattern partially but not completely obscures the prior printed entry.

22. The card of claim 20 in which the cross-out pattern completely obscures the prior printed entry.

23. The card of claim 20 in which the printable area is a thermally printable area and both the prior printed entry and the new printed entry are direct thermally printed in the thermally printable area.

24. A method of processing a transaction card comprising:
accessing account reference information encoded by the transaction card;
machine linking the account reference information with a current account status;
locating a prior thermally printed entry on the transaction card along with a remaining printable area for printing a new entry;
thermally printing the new entry within the remaining printable area as a visible indication of the current account status; and
overprinting the prior thermally printed entry as an indication that the prior entry is no longer current.

25. The method of claim 24 including a further step of machine reading the new entry and comparing to the current account status to verify that the new entry provides a visible indication of the current account status.

26. The method of claim 24 including a further step of receiving information that the prior entries have filled the printable area and of moving the transaction card into a bin for storing spent transaction cards.

27. The method of claim 26 including a further step of drawing a new transaction card from a magazine and machine linking the new transaction card to the prior account reference information.

28. The method of claim 24 including a step of relating the current account status to local machine transactions that affect the current account status.

29. The method of claim 28 in which the local machine transactions include results of the play of a gaming machine.
